(19) United States
(12) Patent Application Publication
(10) Pub. No.: US 2011/0251118 A1
(43) Pub. Date: Oct. 13, 2011

(54) ADSORPTION AGENT FOR SEPARATING DYED COMPOUNDS FROM AQUEOUS FORMULATIONS

(75) Inventors: Oliver Bedford, Ober-Ramstadt (DE); Daniela Kropp, Strullendorf (DE); Marina Glesius, Ober-Ramstadt (DE); Olaf Musolf, Nienburg (DE)

(73) Assignee: Henkel AG & Co., KGaA, Dusseldorf (DE)

(21) Appl. No.: 13/164,518

(22) Filed: Jun. 20, 2011

Related U.S. Application Data
(63) Continuation of application No. PCT/EP2009/064516, filed on Nov. 3, 2009.

(30) Foreign Application Priority Data
Dec. 22, 2008 (DE) 10 2008 064 197.9

(51) Int. Cl. C11D 3/37; C08G 65/336

(52) U.S. Cl. 510/466; 525/409; 525/54.3

(57) ABSTRACT

In order to separate dyes from aqueous solutions, an improved adsorption agent is proposed, which can be produced according to a method, wherein in a first reaction step, a multifunctional alcohol is reacted with an alkylene oxide into a star-shaped OH-terminated polyether. In a second reaction step, the polyether is reacted with a silane compound such that at an average more than one alkoxy silane group per molecule polyether is present, and in a third reaction step a cross-linking product is obtained by condensation in the presence of acids, wherein optionally further siloxane group-containing modifying agents can be incorporated, and wherein in a final treatment step, the cross-linked products obtained in said manner are separated and optionally dried or ground,

### CROSS-REFERENCES TO RELATED APPLICATIONS

This is a continuation of International Application No. PCT/EP2009/064516, filed Nov. 3, 2009, which claims priority to German Patent Application No. DE 10 2008 064 197.9, filed Dec. 22, 2008, both of which are hereby incorporated by reference.

### FIELD OF THE INVENTION

The present invention generally relates to adsorption agents for separating interfering substances, and more particularly relates to dyed compounds, from aqueous preparations, washing baths, or effluents.

### BACKGROUND OF THE INVENTION

The purification of dye-containing water using adsorption agents, for example activated carbon or the like, has been known for many years. Although the substances used for this are effective enough for many applications, a need nevertheless exists for selective adsorption agents for dyes.

The publication “Ureasil gels as a highly efficient adsorbent for water purification,” Chem. Mater. 2006, 18, 4142-4146, describes adsorption agents that have been manufactured by crosslinking polyethers via siloxane terminal groups. The polyethers described therein are, however, linear, so that networks can occur only by way of the polyfunctionality of the siloxane terminal groups.

German Application DE 10 2006 009 004 describes polyfunctional star-shaped prepolymers having silyl terminal groups. The products characterized therein form, on hard surfaces, hydrophilic coatings that exhibit a dirt-repelling effect.

This background highlights the need for an improved adsorption agent for the removal of dyes and the like from aqueous baths.

### BRIEF SUMMARY OF THE INVENTION

The present invention is an adsorption agent for separating dyed compounds from aqueous baths, manufacturable according to a method in which, in a first reaction step, a polyfunctional alcohol is converted, by reaction with an alkylene oxide, into a star-shaped OH-terminated polyether; in a second reaction step, the polyether is reacted with a silane compound in such a way that at an average more than one alkoxysilane group per molecule of polyether is present; and in a third reaction step, a crosslinked product is generated by condensation in the presence of acids, such that further siloxane-group-containing modifying agents can also be incorporated if desired; and after which, in a concluding treatment step, the crosslinked products thus obtained are separated out and, if desired, dried or ground.

The products according to the present invention are the crosslinking products of so-called reactive star polymers. The structure of the products is complex in detail, and can therefore best be described by way of a preferred manufacturing method. Identical or at least very similar products can, however, also be prepared using other methods.

Furthermore, other desirable features and characteristics of the present invention will become apparent from the subsequent detailed description of the invention and the appended claims, taken in conjunction with this summary of the invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The adsorption agents according to the present invention are based firstly on a central unit, a polyfunctional alcohol. Alcohols such as glycerol, trimethylolpropane, pentaerythritol, sugar alcohols such as sorbitol, di- and trimers thereof, various sugars, oligomers thereof, and reaction products thereof, can be used in this context as polyfunctional alcohols. The only prerequisite for the selection of these substances is that they possess an OH functionality of 2 and higher. A suitable OH functionality is between 2 and 20, in particular between 3 and 12. An OH functionality of between 6 and 8 has proven particularly successful for practical use.

The adsorption agents according to the present invention furthermore contain polyether chains These polyether chains are preferably manufactured by reacting the aforesaid polyfunctional alcohols with alkylene oxides. Alkylene oxides having 2 to 4 carbon atoms, in particular ethylene oxide and/or propylene oxide, are preferred here. One skilled in the art is capable of adapting the hydrophilicity of the adsorption agents by way of the ratio of ethylene oxide to propylene oxide. For many situations, ratios of ethylene oxide to propylene oxide of between 20:80 and 80:20 are therefore suitable.

The adsorption agents according to the present invention furthermore contain silyl groups. In accordance with the preferred manufacturing method for the adsorption agents, these are introduced by reacting the OH terminal groups of the star-shaped prepolymers with functional silane derivatives. Suitable as a rule are all those functional silane derivatives that comprise a functional group which is reactive with respect to the terminal groups of the prepolymer precursor. Examples are aminosilanes such as (3-aminopropyl)triethoxysilane and N-(2-aminoethyl)(3-aminopropyl)trimethoxysilane, (meth)acrylate silanes such as (3-methacryloxypropyl)trimethoxysilane, (methacryloxymethyl)triethoxysilane, (methacryloxymethyl)methyldimethyloxysilane, and (3-acryloxypropyl)trimethoxysilane, isocyanatosilanes such as (3 -isocyanatopropyl)trimethoxysilane, (3-isocyanatopropyl)triethoxysilane, (isocyanatomethyl)methyldimethoxysilane, and (isocyanatomethyl)trimethoxysilane, aldehyde silanes such as triethoxysilylundecanal and triethoxysilylbutylaldehyde, epoxy silanes such as (3-glycidoxypropyl)trimethoxysilane, anhydride silanes such as 3-(triethoxysilyl)propylsuccinic acid anhydride, halogen silanes such as chloromethyltrimethoxysilane, 3-chloropropylmethyldimethoxysilane, hydroxyl silanes such as hydroxymethyltriethoxysilane, and tetraethyl silicate (TEOS), which are commercially obtainable, for example, from Wacker Chemie GmbH (Burghausen, Germany), Gelest Inc. (Morrisville, Pa., USA), or ABCR GmbH & Co KG (Karlsruhe, Germany) and can be manufacturing in accordance with known methods. It is particularly preferred to react isocyanatosilanes or anhydride silanes with hydroxy-terminated star-shaped polymers. Upon complete reaction of all the hydroxy termini with isocyanatosilanes, star-shaped prepolymers according to the present invention are obtained which carry exclusively residues having siloxane terminal groups. These are linked via a urethane group and the atomic group that is located between the isocyanate group and the silyl group in the initial isocyanatosilane. Upon complete reaction of all hydroxy termini with anhydride silanes, for example 3-(triethoxysilyl)propylsuccinic acid anhydride, star-shaped prepolymers according to the present invention that carry exclusively siloxane terminal groups are obtained. These are linked via an ester group and the atomic group that is located between the anhydride group and the silyl group in the initial anhydride silane.

The adsorption agents according to the present invention can preferably be manufactured by crosslinking the above-described star polymers having siloxane terminal groups. Crosslinking is preferably carried out in an acid environment. pH values between 2 and 6 are suitable, and both organic and inorganic acids can be used.

Particularly preferred adsorption agents according to the present invention are modified with nitrogen groups. It is particularly preferred to construct adsorption agents that possess secondary or tertiary amino groups, ammonium groups, amide groups, in particular cyclic amides, or amine oxide groups. For the adsorption of numerous dyes it is particularly preferred to utilize adsorption agents that possess pyrrolidone side groups, imidazole side groups, and/or pyridine N-oxide groups.

Preferred adsorption agents of this kind can be manufactured by reacting an isocyanate-functional siloxane with imidazole or pyrrolidone, i.e. for example with N(3-amidopropyl)pyrrolidone or N(3-amino)imidazole or similar commercially obtainable derivatives.

In the condensation step, the siloxanes thereby obtained are mixed with the siloxane-modified star-shaped prepolymers prior to addition of the acid, and subjected together to acid condensation.

According to a preferred embodiment of the invention, after they are manufactured the adsorption agents are separated, dried, and if desired ground. It is often possible in this context to manufacture pellets or other shaped elements, by pressing, from the powder obtained by grinding, in order to enable easier dispensing and addition to liquids or in order to package the adsorption agents into columns or filter cartridges.

A further subject of the invention is surfactant-containing washing or cleaning agents containing an adsorption agent according to the present invention. The adsorption agent is contained therein in particular in quantities from 0.01 wt % to 10 wt %, by preference from 0.1 wt % to 8 wt %.

Color transfer inhibitors are intended to prevent dyed textile fabrics from evoking a modified color impression after laundering. This change in the color impression of washed, i.e. clean, textiles can be based on the one hand on the removal of dye components from the textile by the washing or cleaning process (“fading”); on the other hand, dyes dissolved from differently colored textiles can be deposited onto the textile (“discoloration”). The discoloration aspect can play a role even with undyed laundry items when they are washed together with colored laundry items. In order to avoid these undesired side effects of the removal of dirt from textiles by treatment with usually surfactant-containing aqueous systems, washing agents, especially when they are provided as so-called color washing agents for washing colored textiles, contain active substances that are intended to prevent the dissolution of dyes from the textiles or at least to avoid the deposition onto textiles of dissolved dyes present in the washing bath. The same is analogously true for the treatment of colored hard surfaces or the simultaneous treatment of colored and uncolored hard surfaces, for example when washing tableware.

Use of the adsorption agents described above has a particular impact in ten is of preventing the tinting of white textiles or hard surfaces, or those of other colors, by dyes washed out of textiles or hard surfaces, respectively.

A further subject of the invention is therefore the use of an adsorption agent as described above to avoid the transfer of dyes from dyed textiles or hard surfaces onto undyed or differently colored textiles or hard surfaces when they are respectively laundered or cleaned together with, in particular, surfactant-containing aqueous solutions. The use according to the present invention of the adsorption agent can occur, in this context, by the fact that the adsorption agent is added to an aqueous bath, producible by utilizing any washing or cleaning agent, that is utilized to wash or clean textiles or hard surface; it is preferably implemented, however, by utilizing a washing or cleaning agent according to the present invention that contains the adsorption agent.

A washing or cleaning agent according to the present invention contains, in addition to the adsorption agent described above, at least one surfactant; anionic, nonionic, zwitterionic, and/or amphoteric surfactants can be used. Mixtures of anionic and nonionic surfactants are preferred from an applications-engineering standpoint. The total surfactant content of the washing or cleaning agent is by preference in the range from 0.5 wt % to 60 wt % and particularly preferably from 1 wt % to 45 wt %, based on the entire washing and cleaning agent.

The nonionic surfactants used are preferably alkoxylated, advantageously ethoxylated, in particular primary alcohols having by preference 8 to 18 carbon atoms and an average of 1 to 12 mol ethylene oxide (EO) per mol of alcohol, in which the alcohol residue can be linear or preferably methyl-branched in the 2- position, or can contain mixed linear and methyl-branched residues, such as those that are usually present in oxo alcohol residues. Particularly preferred, however, are alcohol ethoxylates having linear residues made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example, C₁₂₋₁₄ alcohols with 3 EO, 4 EO, or 7 EO, C₉-₁₁ alcohols with 7 EO, C₁₃₋₁₅ alcohols with 3 EO, 5 EO, 7 EO, or 8 EO, C₁₂-₁₈ alcohols with 3 EU, 5 EU, or 7 EO, and mixtures thereof, such as mixtures of C₁₂₋₁₄ alcohol with 3 EU and C₁₂₋₁₃ alcohol with 5 EO. The degrees of ethoxylation indicated represent statistical averages, which can correspond to an integral number or a fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples of these are tallow fatty alcohol with 14 EO, 25 EU, 30 EO, or 40 EO. Nonionic surfactants that contain EO and PO groups together in the molecule are also usable according to the present invention. Block copolymers having EO-PO block units or PO-EO block units, but also EO-PO-EO copolymers or PO-EO-PO copolymers, can be used in this context. Also usable, of course, are mixed alkoxylated nonionic surfactants in which EU and PO units are distributed statistically rather than in block fashion. Such products are obtainable by the simultaneous action of ethylene oxide and propylene oxide on fatty alcohols.

Also usable as further nonionic surfactants are alkyl glycosides of the general formula RO(G)x, in which R corresponds to a primary straight-chain or methyl-branched aliphatic residue, in particular methyl-branched in position 2, with 8 to 22, preferably 12 to 18 carbon atoms, and G is the symbol which denotes a glycose unit with 5 or 6 carbon atoms, preferably glucose. The degree of oligomerization x, which indicates the distribution of monoglycosides and oligoglycosides, is any desired number between 1 and 10; x is preferably 1.2 to 1.4. Alkyl glucosides are known, mild surfactants.

A further class of nonionic surfactants used in preferred fashion, which are used either as the only nonionic surfactant or in combination with other nonionic surfactants, are alkoxylated, preferably ethoxylated or ethoxylated and propoxylated, fatty acid alkyl esters, by preference having 1 to 4 carbon atoms in the alkyl chain, in particular fatty acid methyl esters.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. Further suitable surfactants are polyhydroxy fatty acid amides.

The concentration of nonionic surfactants in the washing or cleaning agent is preferably 5 to 30 wt %, by preference 7 to 20 wt %, and in particular 9 to 15 wt %, based in each case on the entire washing or cleaning agent.

In addition to the nonionic surfactants, the washing or cleaning agent can also contain anionic surfactants. Anionic surfactants that can be used are, for example, those of the sulfonate and sulfate types. Possibilities as surfactants of the sulfonate type are, by preference, C₉₋₁₃ alkylbenzenesulfonates, olefinsulfonates, i.e. mixtures of alkene- and hydroxyalkanesulfonates, and disulfonates, for example such as those obtained from C₁₂-₁₈ monoolefins having a terminal or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the a-sulfonated methyl esters of hydrogenated coconut, palm-kernel, or tallow fatty acids, are likewise suitable.

Further suitable anionic surfactants are sulfonated fatty acid glycerol esters. “Fatty acid glycerol esters” are to be understood as the mono-, di- and triesters, and mixtures thereof, that are obtained during the production by esterification of a monoglycerol with 1 to 3 mol fatty acid, or upon transesterification of triglycerides with 0.3 to 2 mol glycerol.

Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium, salts of the sulfuric acid semi-esters of the C₁₂ to C₁₈ fatty alcohols, for example from coconut fatty alcohol, tallow fatty alcohol, lauryl, myristyl, cetyl, or stearyl alcohol, or the C₁₀ to C₂₀ oxo alcohols, and those semi-esters of secondary alcohols of those chain lengths. Additionally preferred are alk(en)yl sulfates of the aforesaid chain length that contain a synthetic straight-chain alkyl residue produced on a petrochemical basis, which possess a breakdown behavior analogous to those appropriate compounds based on fat-chemistry raw materials. For purposes of washing technology, the C₁₂ to C₁₆ alkyl sulfates and C₁₂ to C₁₅ alkyl sulfates, as well as C₁₄ to C₁₅ alkyl sulfates, are preferred. 2,3-Alkyl sulfates that can be obtained, for example, as commercial products of the Shell Oil Company under the name DAN®, are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols having an average of 3.5 mol ethylene oxide (EO) or C₁₂₋₁₈ fatty alcohols having 1 to 4 EO, are also suitable.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular ethoxylated fatty alcohols. Preferred sulfosuccinates contain C₈₋₁₈ fatty alcohol residues or mixtures thereof. Particularly preferred sulfosuccinates contain a fatty alcohol residue that is derived from ethoxylated fatty alcohols that, considered per se, represent nonionic surfactants (see below for description). Sulfosuccinates whose fatty alcohol residues derive from ethoxylated fatty alcohols having a restricted homolog distribution are, in turn, particularly preferred. It is likewise also possible to use alk(en)ylsuccinic acid having by preference 8 to 18 carbon atoms in the alk(en)yl chain, or salts thereof.

Soaps are particularly preferred anionic surfactants. Saturated and unsaturated fatty acid soaps, such as the salts of lauric acid, myristic acid, palmitic acid, stearic acid, (hydrogenated) erucic acid and behenic acid, are suitable, as are soap mixtures derived in particular from natural fatty acids, e.g. coconut, palm-kernel, olive-oil, or tallow fatty acids.

The anionic surfactants, including the soaps, can be present in the form of their sodium, potassium, or magnesium salts. The anionic surfactants are preferably present in the form of their sodium salts. A further preferred counterion for anionic surfactants is choline.

The concentration of anionic surfactants in a washing or cleaning agent can normally be up to 30 wt % based on the entire washing or cleaning agent, and is by preference in the range from 0.5 wt % to 25 wt %. Especially in cleaning agents according to the present invention for hard surfaces that are intended to be used in automatic cleaning methods, for example for cleaning tableware, anionic surfactants can optionally be entirely absent.

In addition to the adsorption agent according to the present invention and the surfactant(s), the washing or cleaning agent can contain further ingredients that further improve the applications-engineering and/or aesthetic properties of the washing or cleaning agent. In the context of the present invention, the washing or cleaning agent by preference additionally contains one or more substances from the group of the detergency builders, bleaching agents, bleach catalysts, bleach activators, enzymes, enzyme stabilizers, electrolytes, nonaqueous solvents, pH adjusting agents, perfumes, perfume carriers, fluorescing agents, dyes, thickeners, disintegration agents or adjuvants, hydrotopes, foam inhibitors, silicone oils, soil release polymers, anti-gray agents, optical brighteners, shrinkage preventers, wrinkle protection agents, color transfer inhibitors, antimicrobial active substances, germicides, fungicides, antioxidants, preservatives, corrosion inhibitors, antistatic agents, bittering agents, ironing adjuvants, proofing and impregnating agents, swelling and anti-slip agents, softening components, heavy-metal complexing agents, abrasives, fillers, propellants, and UV absorbers.

With regard to builders, surfactants, polymers, bleaching agents, bleach activators, bleach catalysts, solvents, thickeners, optical brighteners, anti-gray agents, wrinkle protection agents, antistatic agents, glass corrosion inhibitors, corrosion inhibitors, soil repellents, color transfer inhibitors, foam inhibitors, abrasives, disintegration agents and adjuvants, acidifying agents, dyes, fragrances, antimicrobial active substances, UV absorbers, enzymes, enzyme stabilizers, and propellants preferably usable according to the present invention, as well as preferred utilization quantities thereof, reference is made to Application WO 2008/107346.

In addition to the adsorption agent that is essential to the invention, the washing or cleaning agent can, if desired, contain a conventional color transfer inhibitor, for example a polymer or copolymer of cyclic amines such as, for example, vinylpyrrolidone and/or vinylimidazole. Polymers suitable as color transfer inhibitors encompass polyvinylpyrrolidone (PVP), polyvinylimidazole (PVI), copolymers of vinylpyrrolidone and vinylimidazole (PVP/PVI), polyvinylpyridine-N oxide, poly-N-carboxymethyl-4-vinylpyridium chloride, and mixtures thereof. It is particularly preferred to use polyvinylpyrrolidone (PVP), polyvinylimidazole (PVI), or copolymers of vinylpyrrolidone and vinylimidazole (PVP/PVI). The polyvinylpyrrolidones (PVP) preferably possess an average molecular weight from 2,500 to 400,000, and are available commercially, for example, from ISP Chemicals as PVP K 15, PVP K 30, PVP K 60, or PVP K 90, or from BASF as Sokalan® HP 50 or Sokalan® HP 53. The copolymers of vinylpyrrolidone and vinylimidazole (PVP/PVI) preferably have a molecular weight in the range from 5000 to 100,000. A PVP/PVI copolymer is available commercially, for example, from BASF under the designation Sokalan® HP 56.

The quantity of additional color transfer inhibitor of this kind, if present, based on the total quantity of the washing or cleaning agent, is preferably in the range from 0.01 to 2 wt %, in particular from 0.05 to 1 wt %, and more preferably from 0.1 to 0.5 wt %.

It is also possible, however, to use enzymatic systems encompassing a peroxidase and hydrogen peroxide, or a substance yielding hydrogen peroxide in water, as color-transfer-inhibiting active substances that are additionally contained, if applicable, alongside the adsorption agents according to the present invention. The addition of a mediator compound for the peroxidase, for example an acetosyringone, a phenol derivative, or a phenothiazone or phenoxazine, is preferred in this case; the aforementioned polymeric color transfer inhibitors can additionally be used if desired.

The pH of a liquid washing or cleaning agent is preferably between 4 and 10, particularly preferably between 6.5 and 9, and most preferably between 7 and 8.8.

Liquid washing or cleaning agents according to the present invention preferably have viscosities in the range from 200 to 5000 mPas, values between 300 and 2000 mPas and in particular 400 and 1000 mPas being particularly preferred. The viscosity can be determined using known methods, e.g. with the aid of a Brookfield LVT-II viscosimeter at 20 rpm and 20° C., spindle 3.

The washing or cleaning agents according to the present invention can be used to wash and/or clean textile fabrics, for example articles of clothing, carpets, or textile wall coverings, or to clean hard surfaces, for example floor surfaces, bathroom tiles, work surfaces for food preparation, or tableware.

The washing and cleaning agents according to the present invention can be present as a liquid or in the form of solid particles, in the latter case particularly as powders, granulates, extrudates, or also as shaped elements, for example tablets. They are manufactured by means of usual and known methods and processes.

### EXAMPLES

### Example 1

Manufacture of unfunctionalized gels

Initial materials:

Silyl-terminated star polymer manufactured according to Example 1 of DE 10 2006 009 004 A1.
Buffer solution, pH 3 (citrate/hydrochloric acid, Merck, 1.09883 Titrisol).

Procedure:

a) Weigh out 4g of star polymer along with 16 g of buffer solution, and agitate. Then leave the sample to stand for a while so that bubbles can rise (product has gelled after 1 hour), and then leave undisturbed to gel further at 50° C. for several hours. Store product in a desiccator to dry.
b) Weigh out 12 g of star polymer along with 48 g of buffer solution, and agitate until a visually homogeneous mixture forms. Place mixture in an ultrasonic bath for a few minutes in order for air bubbles to rise. Allow mixture to gel at 50° C. overnight; this results in a gel that is slightly cloudy near the bottom and still has a few bubbles at the top. Dry gel in desiccator then in a drying cabinet at 50° C.

Results:

Day 7:
a) Weight has not decreased. Samples placed in a drying oven at 50° C. to dry.
b) Weight has decreased by 13.74 g; mass loss=22.9%.

Day 9:
a) Weight has decreased by 5.23 g from initial weight; loss=26.15%.
b) Weight has decreased by 17.36 g from initial weight; samples placed in a drying oven at 50° C. to dry. Loss=28.93%.

Day 10:
a) Weight has decreased by 8.64 g; mass loss=43.2%.
b) Weight has decreased by 25.94 g; loss=43.23%.

Day 15:
a) Weight has decreased by 13.11 g; mass loss=65.55%.
b) Weight has decreased by 45.82 g; mass loss=76.37%.

Day 16:
a) Mass remains constant.
b) Mass has decreased by 45.90 g; mass loss=76.5%.

Day 17:
a) Unchanged.
b) Mass has decreased by 45.93 g; mass loss=76.55%.

Day 18:
a) Unchanged.
b) Mass is constant.

### Example 2:

Use of unfunctionalized gels as adsorbent for dyes from aqueous solution.

Dyes tested:

Orange II C.I. (Acid Orange 7); molecular weight: 350.33 g/mol; supplier: Aldrich; lot: 10903HC-028.
Crystal Violet; molecular weight: 407.99 g/mol; supplier: Aldrich; lot: 077K07401.
Pyrene-1,3,6,8-tetrasulfonic acid tetrasodium salt hydrate; molecular weight: 610.42 g/mol; supplier: Fluka; lot: 1325712 42907284.
Acid Blue 113 (Telon marine AMF); supplier: DyStar; batch: NG47633.

Procedure:

Solutions having a dye concentration of 5 mg in 100 ml deionized water (1 mg/100 ml for Crystal Violet) were prepared in a 100 ml volumetric flask. UV-vis spectra of the solutions were acquired (layer thickness=1 cm). 120 mg dried hydrogel from Example 1 a) (=30 g/1 of dye solution) was then added to each cuvette and left to stand for one day. UV-vis spectra. were then acquired again. The decrease in light absorption is directly proportional to the quantity of dye adsorbed in the hydrogel.

As is evident, the hydrogel represents an effective adsorbent for all the dyes investigated.

Absorption for Acid Orange at approx. 475 nm: without hydrogel=0.43; with hydrogel after 1 day=0.17.

Absorption for Acid Blue at approx. 570 nm: without hydrogel=0.27; with hydrogel after 1 day=0.10.

### Example 3:

Use of unfunctionalized gels as decolorizing agents for red wine
Place 120 mg dried hydrogel in a cuvette together with a commercially usual red wine and leave to stand for one day. After a day the gel is dark-red in color; the supernatant solution has only a light brownish color.

The gels according to the present invention can thus also be used for the adsorption of natural substances.

### Example 4:

Production of micronized gels

Initial materials:

Hydro-STELLAN S, silyl-terminated star polymer (SusTech)
Buffer solution, pH 3 (citrate/hydrochloric acid, Merck, 1.09883 Titrisol)

Procedure:
a) Weigh out 3 g Hydro-STELLAN S with 12 g of buffer solution, and agitate. Then allow the sample to stand so that bubbles can rise. The sample gels in about 15 min. Then dry the sample in a drying cabinet at 50° C. to constant weight.
b) Allow pure Hydro-STELLAN S to cure (duration: 28 days) at room temperature without additives in a GC ampoule, then cut/remove it from the GC flask and decant.
c) Take half of sample a) after drying, cool with liquid nitrogen until sample is hard, then comminute/pulverize in a mortar.
d) Allow pure Hydro-STELLAN S to cure at 50° C. (11 days); then cool with liquid nitrogen until sample is hard, then comminute/pulverize in a mortar.
e) Allow a 20% mixture of Hydro-STELLAN S and pH 3 buffer solution to gel at 50° C. while stirring with a dissolver/stirrer; then dry in a drying cabinet at 50° C. to constant weight.

Result:
a) 3.03 g cut-resistant tablets
b) sticky substance
c) fine flakes
d) sticky small lumps
e) 7.2 g lumps of various sizes

### Example 5:

Use of micronized gels as an adsorbent for Acid Blue 113

Initial materials:

Samples a) to e) from Example 4
Acid Blue 113, Telon marine AMF (DyStar)

Procedure:

Solutions with a dye concentration of 2 mg in 100 ml deionized water were prepared in a 100 ml volumetric flask. UV-vis spectra of the solutions were acquired (layer thickness=1 cm). 120 mg dried hydrogel (=30 g/1 of dye solution) was then added to each cuvette and left to stand for 2 hours and for one day. UV-vis spectra were then acquired again. For better comparability, all the spectra were standardized computationally to the absorption at 700 nm (negligible Acid Blue extinction and low scattering losses).
With samples 4 b) and 4 d), interference due to severe light scattering was observed.

Appearance of the solutions:

Sample 4 a): Thick, hard, brittle lump, very solid even in dye solution; dyes deposits at edges.
Sample 4 b): Soft, sticky, rubbery lump; swells in dye solution.
Sample 4 c): Coarse powder, stable as powder in dye solution.
Sample 4 d): Begins as sticky powder, but becomes a moderately soft lump after a few days in the dye solution.
Sample 4 e): Moderately soft lump, swells in dye solution.
Samples 4 c) and 4 e) in particular display a strongly clarifying effect on the supernatant solution.

### Example 6:

Use of polyvinylpyrrolidone to functionalize the gels
Prepare a mixture of 3 g Hydro-STELLAN S (corresponding to 20%) and 0.3 g Sokalan HP 53 (BASF; 10% based on star polymer) in 12 g pH 3 buffer and agitate. Then dry the sample in a drying cabinet at 50° C. to constant weight.
After 11 days: 3.12 g of constant-weight product; product was then comminuted in a mortar.

### Example 7:

Use of polyvinylpyrrolidone/polyvinylimidazole copolymers to functionalize the gels
Prepare a mixture of 3 g Hydro-STELLAN S (corresponding to 20%) and 0.3 g Sokalan HP 56 (BASF; 10% based on star polymer) in 12 g pH 3 buffer and agitate. Then dry the sample in a drying cabinet at 50° C. to constant weight.
After 11 days: 3.06 g of constant-weight product; product was then comminuted in a mortar.

### Example 8:

Production of a pyrrolidone silane

Initial materials:

3-Isocyanatopropyltrimethoxysilane, 95%; M=205.29 g/mol; d=1.084 g/ml (ABCR); 1-(3-aminopropyl)-2-pyrrolidone, approx. 98%; M =142.29 g/mol; d =1.014 g/ml (Aldrich); Isopropanol (IPA).

Procedure:

Use a syringe to slowly withdraw 0.619 g (0.571 ml; 2.864 mmol; 1.0 eq) 3-isocyanatopropyltrimethoxysilane and place it in a 50 ml round bottom flask together with 1.290 g IPA and a stirring bar. Fit the round bottom flask with a dropping funnel, into which are then placed 0.413 g (0.407 ml; 2.846 mmol; 1.0 eq) 1-(3-aminopropyl)-2-pyrrolidone (withdrawn with a syringe) and 1.118 g IPA. Drip the amino-pyrrolidone solution into the NCO silane (approx. one drop every two seconds) with vigorous stirring. To prevent greater heating of the reaction solution, cool the flask with a water bath.

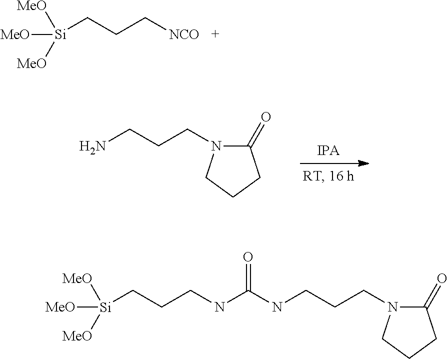

After 16 hours, a slightly yellowish reaction solution is obtained.

Result:

The pyrrolidone silane is present in the form of a theoretically 29.1% solution in IPA.

### Example 9:

Production of pyrrolidone-functionalized gels
Mix 2×3 g Hydro-STELLAN S and 0.99 g of the pyrrolidone silane (10% silane based on the Hydro-STELLAN S) from Example 8 with 13.2 g pH 3 buffer, agitate, let stand until it gels, then allow one sample to dry at 50° C. and one at 80° C. in a drying cabinet to constant weight (=samples 9 a) and 9 b)).
Sample 9 a): The sample is at constant weight after 7 days and has a mass of 3.52 g; it was then comminuted in a mortar.
Sample 9 b): The sample is at constant weight after 3 days and has a mass of 3.28 g; it was then comminuted in a mortar.

### Example 10:

Production of an imidazole silane

Initial materials:

3-Isocyanatopropyltrimethoxysilane, 95%; M=205.29 g/mol; d=1.084 g/ml (ABCR); 1-(3-aminopropyl)-imidazole, approx. 98%; M=125.18 g/mol; d=1.049 g/ml (Aldrich); Isopropanol (IPA).

Procedure:

Use a syringe to slowly withdraw 0.656 g (0.605 ml; 3.036 mmol; 1.0 eq) 3-isocyanatopropyltrimethoxysilane and place it in a 50 ml round bottom flask together with 1.303 g IPA and a stirring bar. Fit the round bottom flask with a dropping funnel, into which are placed 0.387 g (0.369 ml; 3.030 mmol; 1.0 eq) 1-(3-aminopropyl)-imidazole and 1.001 g IPA (withdrawn with a syringe). Drip the amino-imidazole solution into the NCO silane (approx. one drop every two seconds) with vigorous stirring. To prevent greater heating of the reaction solution, cool the flask with a water bath.

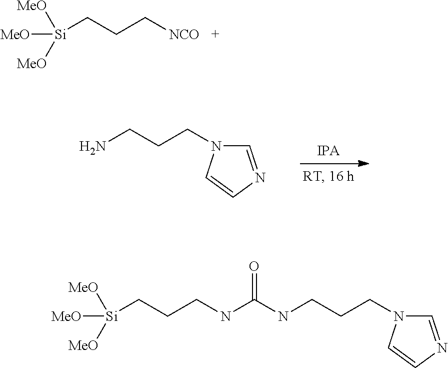

After 16 hours, a slightly yellowish reaction solution is obtained.

Result:

The imidazole silane is present in the form of a theoretically 30.3% solution in IPA.

### Example 11:

Production of imidazole-functionalized gels
Mix 2×3 g Hydro-STELLAN S and 1.031 g of the imidazole silane (10% silane based on the Hydro-STELLAN S) from Example 10 with 13.2 g pH 3 buffer, agitate, let stand until it gels, then allow one sample to dry at 50° C. and one at 80° C. in a drying cabinet to constant weight (=samples 11 a) and 11 b)).
Sample 11 a): The sample is at constant weight after 7 days and has a mass of 3.32 g; it was then comminuted in a mortar.
Sample 11 b): The sample is at constant weight after 6 days and has a mass of 3.22 g; it was then comminuted in a mortar.

### Example 12:

Use of functionalized gels as adsorbent for Acid Blue 113

Solutions with a dye concentration of 2 mg in 100 ml deionized water were prepared in a 100 ml volumetric flask. UV-vis spectra of the solutions were acquired (layer thickness=1 cm). 120 mg dried hydrogel (=30 g/1 of dye solution) was then added to each cuvette and left to stand for 2 hours and for one day. UV-vis spectra were then acquired again. For better comparability, all the spectra were standardized computationally to the absorption at 700 nm (negligible Acid Blue extinction and low scattering losses).
Samples 9a, 9b, and 11 “a” or “b” or “11a” and “11b”, in particular, exhibited a strong decolorizing effect on the supernatant bath.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An adsorption agent for separating dyed compounds from aqueous baths, manufactured according to a method in which, in a first reaction step, a polyfunctional alcohol is converted, by reaction with an alkylene oxide, into a star-shaped OH-terminated polyether; in a second reaction step, the polyether is reacted with a silane compound in such a way that, at an average, more than one alkoxysilane group per molecule of polyether is present; and in a third reaction step, a crosslinked product is generated by condensation in the presence of acids, wherein, optionally, siloxane-group-containing modifying agents are incorporated; and after which, in a concluding treatment step, the crosslinked product thus obtained is separated out and, optionally, dried or ground.

2. The adsorption agent according to claim 1, wherein the alcohol component used for the manufacture thereof has a functionality from 2 to 20.

3. The adsorption agent according to claim 1, wherein the alcohol component used for the manufacture thereof is selected from the group consisting of glycerol, trimethylolpropane, pentaerythritol, sugars, sugar alcohols, and di- or trimers of sugars or sugar alcohols, as well as derivatives of said compounds.

4. The adsorption agent according to claim 3, wherein ethylene oxide and/or propylene oxide was used as an alkylene oxide for the manufacture thereof.

5. The adsorption agent according to claim 4, wherein the molar ratio of ethylene oxide to propylene oxide is between 80:20 and 20:80.

6. The adsorption agent according to claim 1, wherein the silane compounds used for the manufacture thereof are silanes or halogen silanes having 1 to 3 alkoxide groups.

7. The adsorption agent according to claim 1, wherein the functionalized silanes used for the manufacture thereof contain at least one isocyanate group and 1 to 3 alkoxide groups.

8. The adsorption agent according to claim 1, wherein a crosslinking step at a pH between 1 and 6 was carried for the manufacture thereof.

9. The adsorption agent according to claim 1, wherein alkoxide silanes that possess an additional nitrogen-containing functional group selected from the group consisting of an amine group, amide group, ammonium group, or amine N-oxide group, were used as a modifying agent in crosslinking.

10. The adsorption agent according to claim 9, wherein the modifying agent used for the manufacture thereof contains an imidazole group, pyridine N-oxide group, and/or pyrrolidone group.

11. A washing or cleaning agent containing surfactant and an adsorption agent according to claim 1.

12. Use of an adsorption agent according to claim 1 to avoid the transfer of dyes from dyed textiles or hard surfaces onto undyed or differently colored textiles or hard surfaces when they are respectively laundered or cleaned together with surfactant-containing aqueous solutions.
